(19) United States
(12) Patent Application Publication
(10) Pub. No.: US 2009/0216960 A1
(43) Pub. Date: Aug. 27, 2009

(54) Multi Port Memory Controller Queuing

(76) Inventors: Brian David Allison, Rochester, MN (US); Joseph Allen Kirscht, Rochester, MN (US); Elizabeth A. McGlone, Rochester, MN (US)

Correspondence Address: Matthew C. Zehrer;IBM Corporation, Dept. 917, 3605 Highway 52 North, Rochester, MN, 55901-7829, US

(21) Appl. No.: 12/038,192

(22) Filed: Feb. 27, 2008

(51) Int. Cl. G06F 12/00

(52) U.S. Cl. 711/149; 711/E12.001

(57) ABSTRACT

The present invention is generally directed to a method, system, and program product wherein at least two memory ports associated within a memory controller are capable of transferring commands between one another in unbalanced memory configurations. When the first memory port can no longer accept commands and a second memory port is able to accept commands, the second memory port accepts the commands that the first memory port can not. When the first memory port is able to accept commands, and there are commands in the second memory port that should have been in the first memory port, the commands in the second memory port are transferred to the first memory port.

### RELATED FILINGS

The present invention is related to co pending application entitled, Multi Port Memory Controller Queuing, attorney docket number ROC920070048US1.

### FIELD OF THE INVENTION

The present invention generally relates to a memory controller, and more particularly, to a method, apparatus, and program product for improved queuing in a memory controller having two or more memory modules and in an unbalanced memory configuration.

### SUMMARY

Since the dawn of the computer age, computer systems have evolved into extremely sophisticated devices that may be found in many different settings. Computer systems typically include a combination of hardware (e.g., semiconductors, circuit boards, etc.) and software (e.g., computer programs). One key component in any computer system is memory.

Modern computer systems typically include dynamic random-access memory (DRAM). DRAM is different than static RAM in that its contents must be continually refreshed to avoid losing data. A static RAM, in contrast, maintains its contents as long as power is present without the need to refresh the memory. This maintenance of memory in a static RAM comes at the expense of additional transistors for each memory cell that are not required in a DRAM cell. For this reason, DRAMs typically have densities significantly greater than static RAMs, thereby providing a much greater amount of memory at a lower cost than is possible using static RAM.

It is increasingly more common in modern computer systems to utilize a chipset with multiple memory controller (MC) ports, each associated with the necessary command queue structure for memory read and write commands. During high level architecture/design process, queuing analysis is typically performed to determine the queue structure sizes necessary for the expected memory traffic. In this analysis, it is also determined at which point a full indication must be given to stall the command traffic to avoid a queue overflow condition. This is accomplished by determining the maximum number of commands that the queue structure must accept even after the queue structure asserts that it is full. Herein queue structures (i.e., registers, queue systems, queue mechanisms, etc.) are referred to as queues.

As the number of commands that a queue must sink during a given clock cycle is increased, the number of commands it must sink after asserting that it is nearly full increases. For example, if a queue only sinks 1 command per cycle and the pipeline feeding the queue is 3 clock cycles, then the queue needs to be able to sink up to 3 possible commands in the pipeline after asserting that it is nearly full. If the queue sinks up to 4 commands per cycle and the pipeline feeding the queue is 3 clock cycles, then the queue needs to be able to sink up to 12 possible commands after asserting that it is nearly full. Without sufficient queue depth, the full assertion will stall command traffic much more frequently and adversely affect system performance.

In a computer system having multiple memory ports, system performance is optimized when all memory ports are populated and are arranged in a balanced configuration. A balanced memory configuration results in all queues being utilized and the memory accesses being distributed relatively evenly across all queues. If one or more of the available memory ports are not populated, the populated port's queues must handle the load. This may result in the populated port's queues having to sink additional commands per clock cycle. Sinking more commands per cycle results in having to assert the nearly full condition when the queue is less full. This is done to leave room for more commands that may be in flight to the memory controller.

To realize sufficient system performance when the memory ports are not arranged in a balanced configuration, it is common to increase queue sizes to minimize the frequency of queue full conditions for such configurations. These additional queue entries are not required to realize sufficient performance when the memory ports are arranged in a balanced configuration. The additional queue entries result in increased chip area, increased complexity for selecting commands from the queue, increased capacitive loading, and increased wiring congestion and wire lengths. These factors can make it difficult to perform all necessary functions in the desired period of time. This may ultimately result in adding additional clock cycles to the memory latency, which may adversely affect system performance.

The present invention is generally directed to a method, system, and program product wherein at least two memory ports are contained within a memory controller, the memory controller being a part of a memory configuration which may be a balanced or unbalanced configuration. In an embodiment of the invention the memory controller has the capability to transfer a command from a first queue to a second queue. In certain embodiments this may effectively expand the functional queue sizes in unbalanced memory configurations.

In a particular embodiment, a first memory port may become unable to sink commands (i.e., if the queue in the first memory port becomes full or nearly full). A second memory port, however, may have availability (i.e., excess capacity, etc) to sink commands. In a particular embodiment the second memory port may accept excess commands (i.e., commands that would be otherwise accepted by the first memory port if the first memory port had the capacity). In another embodiment when the first memory port has availability after a period of non-availability, and there are excess commands in the second memory controller, the excess commands are transferred to the first memory controller. In another embodiment when the first memory port has availability after a period of non-availability, and there are no excess commands in the second memory controller, the first memory port may accept the expected or normal command flow (i.e., mainline command flow, etc.). In certain embodiments, the transferring of excess commands effectively enlarges the first memory port's queue depth, allowing for an improved system performance affect.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates a computer system having at least one processor and a memory controller having at least one memory port in accordance with an embodiment of the present invention.

FIG. 2 illustrates a system for queue interconnection according to an embodiment of the present invention.

FIG. 3A illustrates a queue interconnection scheme in accordance with an embodiment of the present invention.

FIG. 3B illustrates another queue interconnection scheme in accordance with an embodiment of the present invention.

FIG. 4 illustrates a memory controller having four memory ports according to an embodiment of the present invention.

FIG. 5a illustrates a queue partition separator in a first position in accordance with an embodiment of the present invention.

FIG. 5b illustrates a queue partition separator in a second position in accordance with an embodiment of the present invention.

FIG. 5c illustrates a queue partition separator in a third position in accordance with an embodiment of the present invention.

FIG. 6 illustrates a method to determine the manner of writing commands to local memory in accordance with an embodiment of the present invention.

FIG. 7 illustrates a method to determine the routing of commands through the queues of a memory controller in accordance with an embodiment of the present invention.

FIG. 8 illustrates an article of manufacture or a computer program product in accordance with an embodiment of the present invention.

### DETAILED DESCRIPTION OF THE PREFERRED EMBODIMENTS

The present invention relates to a memory controller for processing data in a computer system. The following description is presented to enable one of ordinary skill in the art to make and use the invention and is provided in the context of a patent application and its requirements. Various modifications to the embodiments and the generic principles and features described herein will be readily apparent to those skilled in the art. Thus, the present invention is not intended to be limited to the embodiments shown but is to be accorded the widest scope consistent with the principles and features described herein.

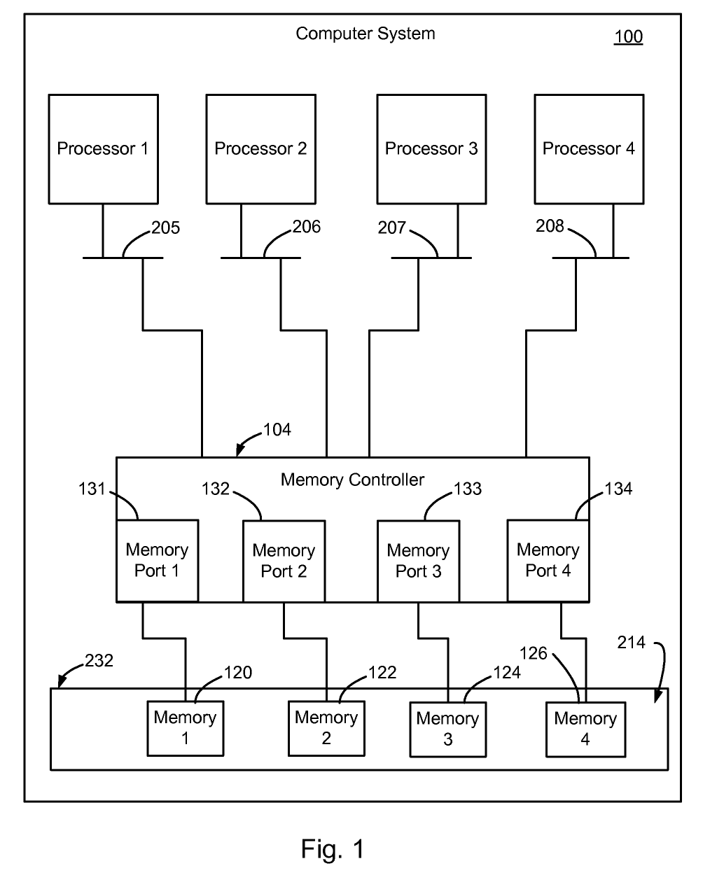

FIG. 1 is a block diagram of a computer system 100 including a memory controller 104 in accordance with an embodiment of the present invention. The computer system 100 comprises one or more processors coupled to a memory controller 104, via one or more busses. The computer system 100 comprises at least a first processor coupled to memory controller 104 via a bus 205 or other connection structure. Computer system 100 may also comprise a second processor connected to memory controller 104 via a bus 206, a third processor connected to memory controller 104 via a bus 207, and a fourth processor connected to memory controller via a bus 208. Alternatively more than one processor may be connected to memory controller 104 via any particular bus. Memory controller 104 may be external to each processor, or may be integrated in to the packaging of a module (not shown), the module including each processor and the memory controller, or may be otherwise integrated into a processor. Although the computer system 1 00, as shown in FIG. 1, utilizes four processors, computer system 100 may utilize a larger or smaller number of processors. Similarly, computer system 100 may include a larger or smaller number of busses than as shown in FIG. 1.

The memory controller 104 may be coupled to a local memory (e.g., one or more DRAMs, DIMM, or any such equivalent physical memory) 214. More specifically, the memory controller 104 may include a plurality of memory ports (i.e., first memory port 131, second memory port 132, third memory port 133, and fourth memory port 134) for coupling to the local memory 214. For example, each memory port 131-134 may couple to a respective memory module (e.g., DRAM, DIMM, or any such memory module) 120-126 respectively, included in the local memory 214. In other words one or more memory modules may be populated or otherwise installed into computer system 100. Although the memory controller 104 includes four memory ports, a larger or smaller number of memory ports may be employed. The memory controller 104 is adapted to receive requests for memory access and service such requests. While servicing a request, the memory controller 104 may access one or more memory ports 131-134. The memory controller 104 may include any suitable combination of logic in addition to the specific logic discussed below, registers, memory or the like, and in at least one embodiment may comprise an application specific integrated circuit (ASIC).

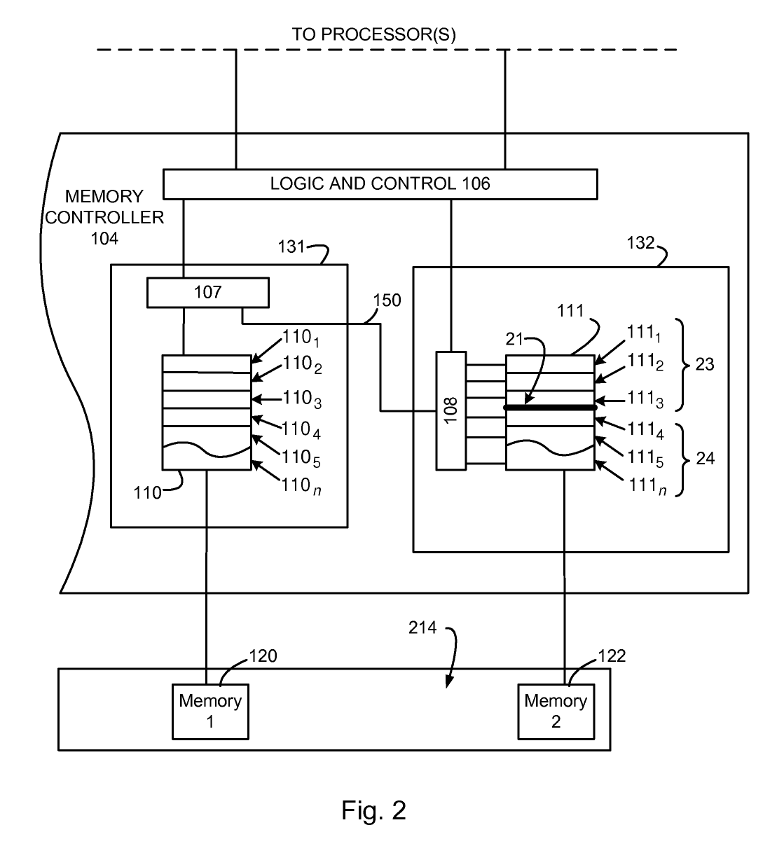

FIG. 2 illustrates a system for queue interconnection according to an embodiment of the present invention. FIG. 2 illustrates interconnected queue 110 and 111 in accordance with another embodiment the present invention. In the illustrated embodiment the memory configuration is unbalanced (an unbalanced configuration is further described below). Memory controller 104 comprises logic and control (i.e., 106, 107, and 108), a first memory port 131, and a second memory port 132, herein referred to as memory port 131 and memory port 132 respectively. A queue 110 is associated with (i.e., contained in, connected to, linked to, etc.) memory port 131 and queue 111 is associated within memory port 132. Memory controller 104 receives commands from one or more processors and is configured to write/sink those commands to local memory 214. In a particular embodiment these commands may be altered (e.g., reformatted to get the command in the correct format to write to memory), resulting in related commands being written to memory module 120 rather than the actual commands from processors 204 written to memory module 120.

In a particular embodiment, there are at least two memory ports within memory controller 104, though only two are shown in FIG. 2 (memory ports 131 and 132). In a particular embodiment queues 110 and 111 are queues having similar properties (e.g., queue type, queue size, arbitration schemes utilized, etc.). In an alternative embodiment the queues 110 and 111 are queues having different properties. Queues 110 and 111 have multiple queue entries. As shown, in FIG. 2, queue 110 has “n” queue entries 110₁-110ₙ and queue 111 has “n” queue entries 111₁-111ₙ.

Memory controller 104 receives commands from the one or more processors and the commands are routed and/or processed by logic and control 106. Logic and control 106 is an element that controls or otherwise ensures that specific commands are routed to correct memory port. Logic and control 107 is an element that controls which command enters queue 110. Logic and control 108 is an element that controls which command enters queue 111. Though only one of each logic and control 107 and 108 are shown, in other embodiments multiple logic and controls 107 and 108 may be utilized. In still other embodiments logic and control 106, 107, and 108 may be combined or otherwise organized.

In the present embodiment shown in FIG. 2 the memory configuration is unbalanced. Memory module 120 is utilized (i.e., present, installed, populated, etc.) and is receiving commands from memory controller 104. Likewise, memory module 122 is also utilized and is receiving commands from memory controller 104. However the capacity of memory module 120 is relatively larger than the capacity of memory module 122 (e.g., memory module 120 may be 2 GB, and memory module 122 may be 1 GB). This present configuration having a memory capacity differential is an example of an unbalanced memory configuration. Others skilled in the art realize that there may be other configurations resulting in an unbalanced memory configuration.

In many instances, one or more commands need to be directed to queue 110, when queue 110 is full, nearly full, or otherwise lacks capacity. These one or more commands are herein referred to as excess commands. In previous designs these excess commands were not routed through the memory port until a command had exited the queue or the queue had otherwise gained capacity (i.e., the queue sinked a command, etc.).

Queue 111 is partitioned into at least two segments separated from each other by a partition separation 21. For instance, queue segment 23 is a group of queue entries that accept command(s) that are to be routed to memory module 120, and queue segment 24 is a group of queue entries that accept command(s) that are to be routed to memory module 122. Partition separation 21 is dynamic or otherwise movable within queue 111, thereby allowing for the queue segment 23 to have a greater, smaller, or equal to number of queue entries than queue segment 24. Partition separation 21 is dynamic depending on, for instance, the amount of mainline command flow commands routed to the queue 111. For instance if there are many commands to sink to memory module 122, more queue entries are made available in queue segment 24. If there are a small number of commands to sink to memory module 122, more queue entries are made available in queue segment 23.

Queue 110 accepts commands to sink to memory module 120, herein also referred to as 131 commands. Queue 111 may also accept commands to sink to memory module 122, herein also referred to as 132 commands. After some time each queue entry 110₁-110ₙ may become full, nearly full, or may otherwise lack capacity to sink another command. However there may be one or more excess command(s) may be present.

In accordance with the present invention, instead of waiting for a command to exit from queue 110, or waiting for queue 110 to otherwise gain capacity, the excess command(s) are written to queue segment 23, if queue segment 23 has capacity. When queue 110 has sunk a command to memory module 120, the excess command(s) are transferred from queue segment 23 to queue 110. The excess command(s) are written to queue segment 23 until the queue segment 23 is full, or until queue 110 is no longer full. Upon queue 110 no longer being full, the one or more excess commands are transferred from queue segment 23 to queue 110. In a particular embodiment, if both queue 110 and queue segment 23 are full, no other new 131 commands can be routed to queue 110 or queue segment 23 until the queue 110 or queue segment 23 are no longer full or otherwise gain capacity. In another embodiment, command prioritization may be utilized to affect how the commands are routed through queue 110, queue segment 23, and queue segment 24.

Queue-to-queue interface 150 logically connects queue 110 and queue 111 according to an embodiment of the present invention. Queue-to-queue interface 150 is subsystem that transfers data (i.e., a bus, a wide bus, etc.), stored in one queue to another queue. In a particular embodiment multiple queue-to-queue interfaces 150 are utilized to connect queues 110 and 111. When queue 110 is no longer full, the excess command(s) are transferred from queue segment 23 to one or more queue entries 110₁-110ₙ that have capacity. In the embodiment shown in FIG. 2, queue entries 111₁-111ₙ are connected to queue 110 by queue-to-queue interface 150 via logic and control 108. Logic and control 108 controls which entry in queue segment 23 to transfer from. Logic and control 108 and/or logic and control 107 may control which queue entry in queue 110 to transfer the excess command to. Alternatively any of the of queue entries 110₁-110ₙ may be connected to any of the queue entries 111₁-111ₙ.

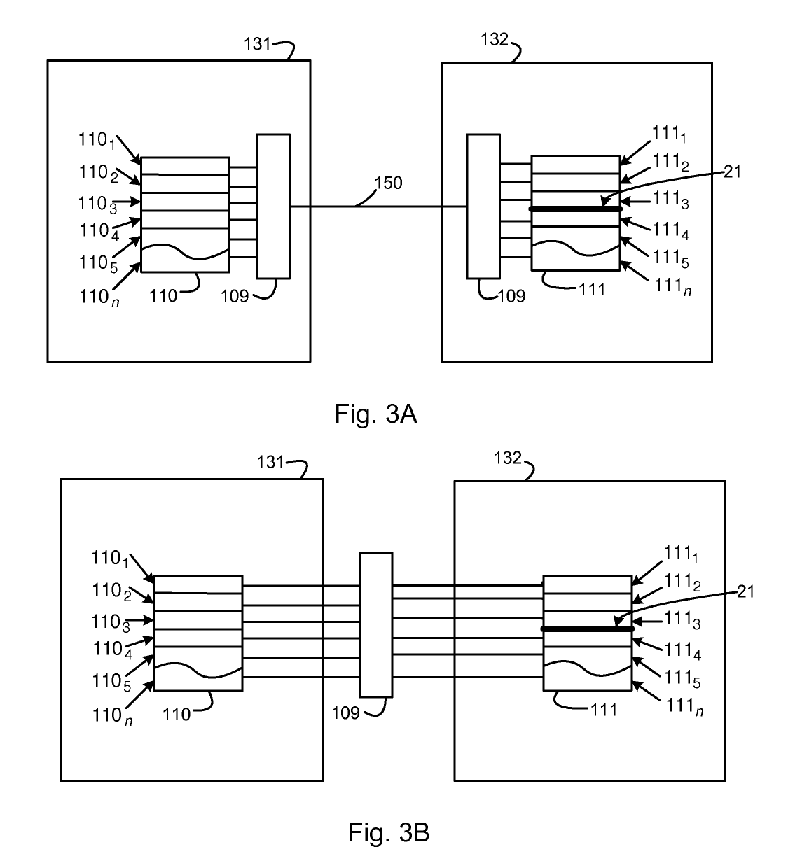

In yet another embodiment, as shown in FIGS. 3A and 3B, any such queue entry(s) 110₁-110ₙ may be connected to any other such queue entry(s) 111₁-111ₙ via queue-to-queue interface 150 and logic and control 109. Logic and control 109 may be the combination of logic and control 106, 107, and 108. Logic and control 109 may also be a separate control element from the other logic and control elements 106, 107, and 108. Further, queues 110 and 111 may be interconnected by any queue interconnection scheme. In the present embodiments logic and control 109 decides and controls from which entry to transfer from and to which entry to transfer to.

In a particular embodiment queue 110, queue segment 23, and queue segment 24 utilize first in first out (FIFO) arbitration logic to control how commands are shifted within each queue. Alternatively queue 110 and queue 111 may utilize any known arbitration logic, prioritization logic, or such to control which of the one or more commands should be shifted or otherwise moved within each queue. In a particular embodiment memory controller 104 is integrated into a particular processor or into the package of one or more processor modules.

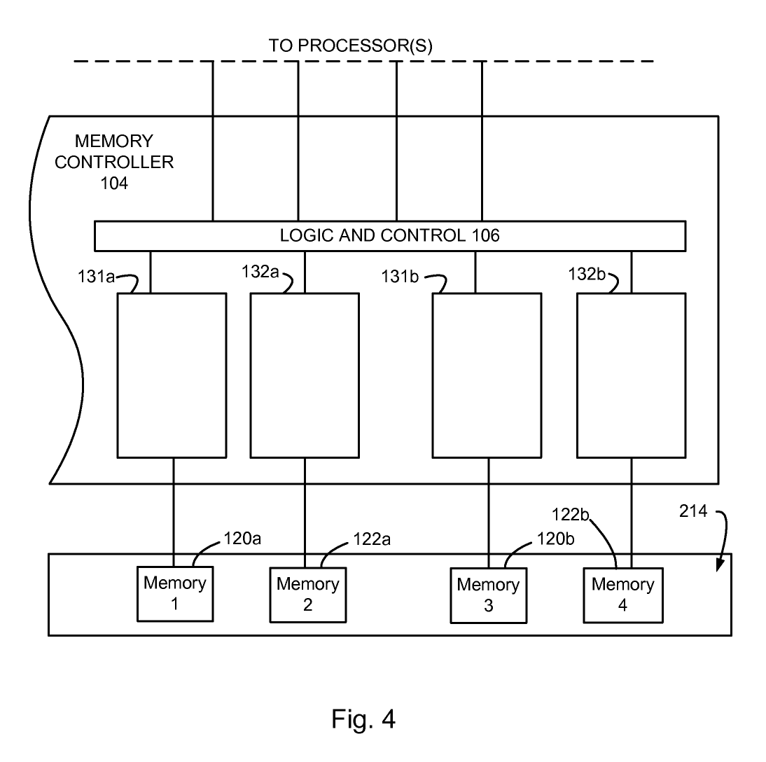

FIG. 4 illustrates memory controller 104 controlling at least four memory ports 131a, 132a, 131b, 132b in accordance with the present invention. An unbalanced memory configuration is shown in FIG. 4. Memory ports 131a and 131b are connected to a utilized memory module 120a and 120b respectively. However the capacity of memory module 120 is a relatively large compared to the capacity of memory module 122. Memory ports 132a and 132b are connected to a utilized memory module 122a and 122b respectively. In other words, FIG. 4 depicts one large memory module and one small memory module per each interconnected queue 131 and queue 132. In another embodiment, it is also possible to utilize two large memory modules per queue 131a and 132a, and two small memory modules per queue 131b and 132b. It is noted that the general numerical enumeration (i.e., queue 131) is used instead of a specific enumeration (i.e., queue 131a) when the description applies to all forms of the specific enumeration (i.e., queue 131a & queue 131b).

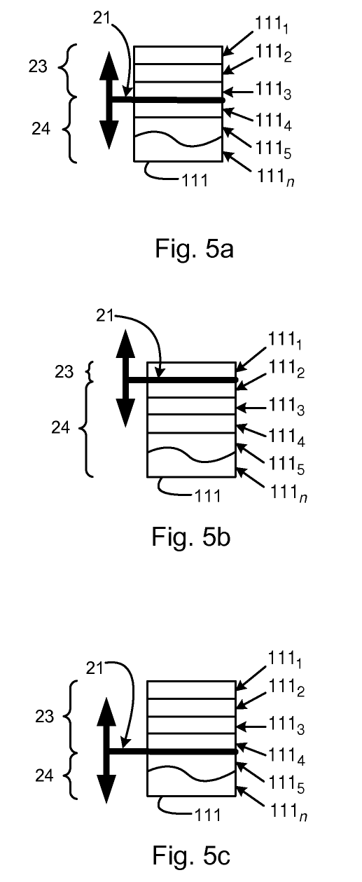

FIG. 5a illustrates partition separation 21 in a first position resulting in a queue segment 23 and queue segment 24. In the first position queue segment 23 comprises queue entries 111₁-111₃, and queue segment 24 comprises queue entries 111₄-111ₙ. Partition separation 21 may be implemented in hardware or software or any such equivalent means. Partition separation 21 may be a virtual separation between queue segment 23 and queue segment 24. The virtual separation may be maintained by for instance by logic and control element 108 or by another logic or control element. FIG. 5b illustrates a partition separation 21 in a second position resulting in a queue segment 23 and queue segment 24. In the second position queue segment 23 comprises queue entry 111₁, and queue segment 24 comprises queue entries 111₂-111ₙ. Partition separation 21 is dynamically adjusted, for instance to the second position if there are many 132 commands to sink to memory module 122 (not shown in FIG. 5b). If for instance there are many 132 commands logic and control 108 may only allow excess command(s) to be written to one queue entry (i.e., 111₁). In this manner logic and control 108 may allow more queue entries (i.e., 111₂-111ₙ) for 132 commands. FIG. 5c illustrates a partition separation 21 in a third position resulting in a queue segment 23 and queue segment 24. In the first position queue segment 23 comprises queue entries 111₁-111₄, and queue segment 24 comprises queue entries 111₅-111ₙ. In other embodiments of the invention queue 110 is also split into queue segments. In other words the queue configurations as described above regarding queue 111, may also be implemented for queue 110.

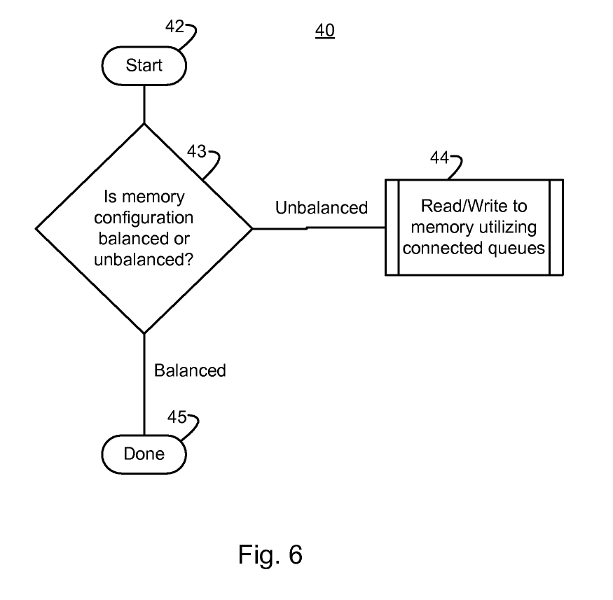

FIG. 6 illustrates a method 40 to determine the manner of writing commands to local memory in accordance with an embodiment of the present invention. Method 40 starts (block 42) when at least two memory modules are installed into a computer system. The two memory modules are installed in an unbalanced memory configuration in accordance with the present invention. It is determined whether the memory configuration will result in a balanced memory configuration or whether the memory configuration will result in an unbalanced memory configuration (block 43). If the memory configuration is projected to result in a balanced memory configuration, commands are written to local memory as previously known (block 45). If the memory configuration may result in a unbalanced memory configuration, commands are written to the one or more memory modules, in accordance with the present invention (block 44).

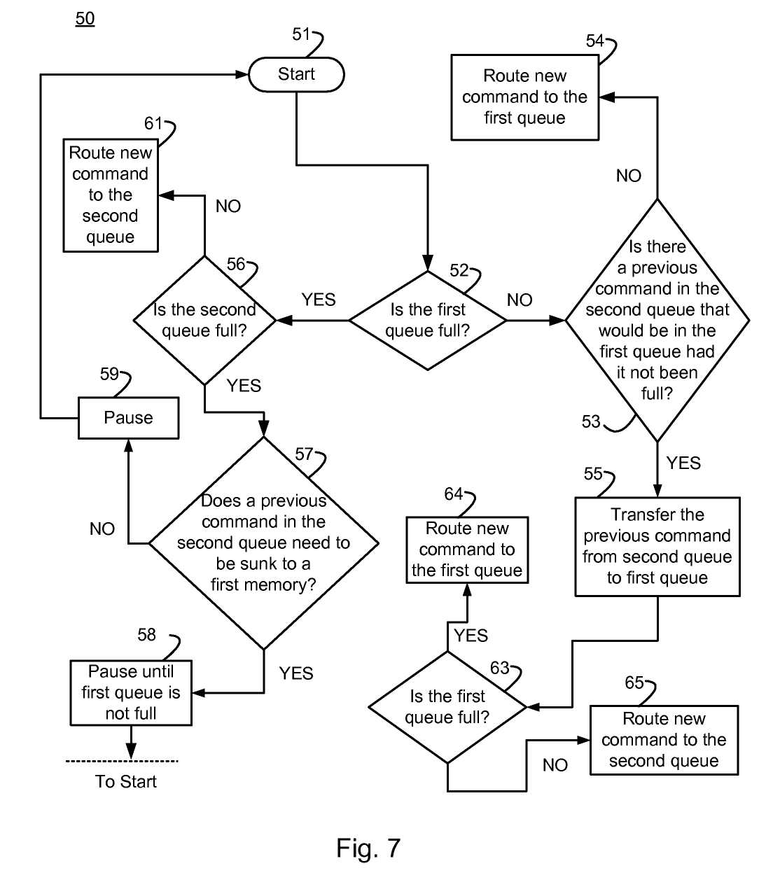

FIG. 7 illustrates a method 50 to determine the routing of commands through the queues of a memory port controller in accordance with the present invention. Method 50 starts (block 51) when at least one new command is to be routed through at least one queue. In order to determine which memory port to route the new command(s) through, it is determined if the first queue is full (block 52). If the first queue is full, it is determined if the second queue is full (block 56). Or alternatively it may be determined if a particular segment of the second queue is full (or nearly full). If the second queue (or the particular second queue segment) is full, it is determined if a previous command in the second queue (or in the particular second queue segment) should be written to a first memory (block 57). If the previous command in the second queue (or in the particular second queue segment) should be written to the first memory module, method 70 should pause until either the first queue or the second queue (or the particular second queue segment) is no longer full (block 59). If the second queue (or the particular second queue segment) is not full, the new command should be routed to or through the second queue (or the particular second queue segment) (block 61). If the first queue is not now full, it is determined if there is a previous command in the second queue (or in the particular second queue segment) that would be in the first queue had the first queue not been full (block 53). Note the previous command as referred to in block 57 may or may not be the same command as referred to in block 53. If there is not a previous command in the second queue (or in the particular second queue segment) that would be in the first queue had the first queue not been full, and the first queue is not now full, the new command is routed to the first queue (block 55). If the previous command is transferred from the second queue (or the particular second queue segment) to the first queue, it is determined which queue (or the particular second queue segment) to route the new command(s) to or through. If the first queue is now full (block 63), the new command should be routed to the second queue (or the particular second queue segment) (block 65). If the first queue is not now full, the new command should be routed to the first queue (block 64).

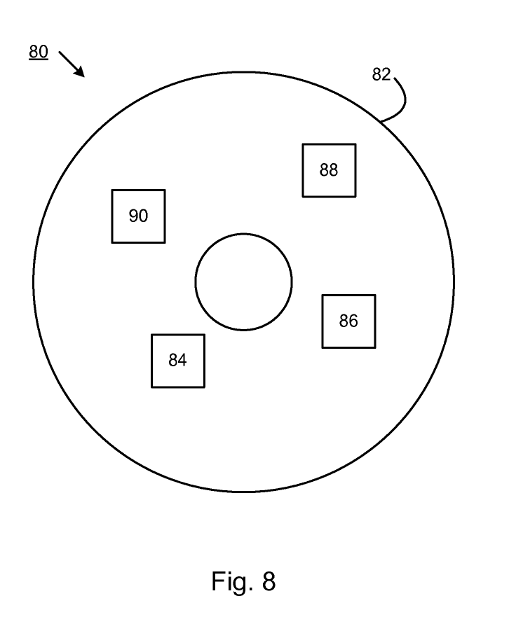

FIG. 8 depicts an article of manufacture or a computer program product 80 of the invention. The computer program product 80 includes a recording medium 82, such as, a non-volatile semiconductor storage device, a floppy disk, a high capacity read only memory in the form of an optically read compact disk (e.g., CD-ROM, DVD, etc.), a tape, a transmission type media such as a digital or analog communications link, or a similar computer program product. Recording medium 82 stores program means 84, 86, 88, and 90 on medium 82 for carrying out the methods for providing multi port memory queuing, in accordance with at least one embodiment of the present invention. A sequence of program instructions or a logical assembly of one or more interrelated modules defined by the recorded program means 84, 86, 88, and 90, direct the computer system for providing memory queuing.

The accompanying figures and this description depicted and described embodiments of the present invention, and features and components thereof. Those skilled in the art will appreciate that any particular program nomenclature used in this description was merely for convenience, and thus the invention should not be limited to use solely in any specific application identified and/or implied by such nomenclature. Thus, for example, the routines executed to implement the embodiments of the invention, whether implemented as part of an operating system or a specific application, component, program, module, object, or sequence of instructions could have been referred to as a “program”, “application”, “server”, or other meaningful nomenclature. Therefore, it is desired that the embodiments described herein be considered in all respects as illustrative, not restrictive, and that reference be made to the appended claims for determining the scope of the invention.

The invention claimed is:

1. A memory system comprising:
a memory controller containing a first memory port associated with a first queue and a second memory port associated with a second queue, and;
a first memory module connected to the first memory port, a second memory module connected to the second memory port, wherein the second queue is configured to accept a command that is to be routed to the first memory module, and;
at least one logic control element configured to control the routing of the command.

2. The memory system of claim 1 further comprising:
a queue partition separator associated with at least the second queue, the queue partition separator dividing the second queue into a first queue segment and a second queue segment.

3. The memory system of claim 2 wherein the first queue segment is configured to accept command(s) to be routed to the first memory module, and wherein a second queue segment is configured to accept command(s) to be routed to the second memory module.

4. The memory system of claim 3 wherein the capacity of the first memory module is larger than the capacity of the second memory module.

5. The memory system of claim 4 wherein the second queue segment accepts the command only after the first queue is full.

6. The memory system of claim 5 wherein after the command is accepted by the first queue segment, it is transferred from the first queue segment to the first queue upon at least an existing command exiting the first queue.

7. The memory system of claim 6 wherein the memory controller is external to a processor, and wherein the memory controller is configured to accept commands from the processor.

8. The memory system of claim 7 wherein the memory controller is integrated in a processor, and wherein the memory controller is configured to accept commands from the processor.

9. The memory system of claim 8 wherein the first queue and the second queue are interconnected by a bus.

10. The memory system of claim 9 wherein the first queue logically shares one or more queue entries with the second queue.

11. The memory system of claim 10 wherein the first queue segment accepts the command only if the first queue segment is not full.

12. A method comprising:
routing a command stream to a first memory module through a first queue, the first queue associated with a first memory port, and;
if the first queue is full, routing at least one subsequent command through a first queue segment of a second queue, the second queue associated with a second memory port, wherein
the first queue segment is a grouping of particular queue entries.

13. The method of claim 12 further comprising:
if the first queue is not full, routing the subsequent command to the first queue.

14. The method of claim 12 further comprising:
upon the first queue no longer being full, transferring the subsequent command from the first queue segment to the first queue.

15. The method of claim 14 further comprising:
routing the subsequent command to the first memory module.

16. The method of claim 15 wherein the first queue logically shares one or more queue entries with the second queue.

17. The method of claim 16 wherein a queue partition separator is associated with at least the second queue, the queue partition separator dividing the second queue into the first queue segment and a second queue segment.

18. The method of claim 12 further comprising:
determining whether a unbalanced memory configuration may occur.

19. A computer program product for enabling a computer to route commands to a memory module comprising:
computer readable program code causing a computer to:
route a command stream through a first queue to a first memory module, the first queue contained in a first memory port, the first memory port associated with a memory controller, and;
if the first queue is full, route at least one subsequent command through a first queue segment of a second queue, the second queue associated with a second memory port, the second memory port associated with the memory controller.

20. The program product of claim 19 wherein the computer readable program code further causes a computer to:
transfer the subsequent command from the first queue segment to the first queue, upon the first queue no longer being full.
route the subsequent command to the first memory module.
